(19) United States
(12) Patent Application Publication
(10) Pub. No.: US 2025/0018361 A1
(43) Pub. Date: Jan. 16, 2025

(54) TITANIUM SOL CARBON SEQUESTRATION ADDITIVE AND PREPARATION METHOD AND USE THEREOF, AND METHOD FOR CARBON SEQUESTRATION OF CEMENT-BASED MATERIAL

(71) Applicant: QINGDAO UNIVERSITY OF TECHNOLOGY, Qingdao (CN)

(72) Inventors: Shaochun LI, Qingdao (CN); Xu CHEN, Qingdao (CN); Mengjun HU, Qingdao (CN); Yongjuan GENG, Qingdao (CN); Zuquan JIN, Qingdao (CN); Song GAO, Qingdao (CN); Dongshuai HOU, Qingdao (CN)

(21) Appl. No.: 18/275,297

(22) PCT Filed: Nov. 18, 2022
(86) PCT No.: PCT/CN2022/132752

§ 371 Date: Aug. 1, 2023

(30) Foreign Application Priority Data
Aug. 18, 2022 (CN) 202210989726.7

(51) Int. Cl. B01J 20/06; B01D 53/62; B01J 20/28; B01J 20/30; C04B 41/00; C04B 41/45; C04B 41/48; C04B 41/63

(52) U.S. Cl. CPC B01J 20/06; B01D 53/62; B01J 20/28026; B01J 20/3042; B01J 20/3085; C04B 41/009; C04B 41/4537; C04B 41/483; C04B 41/63; B01D 2251/404; B01D 2251/604; B01D 2257/504

(57) ABSTRACT

Provided are a titanium sol carbon sequestration additive and a preparation method and use thereof, and a method for carbon sequestration of a cement-based material. The method for preparing the titanium sol carbon sequestration additive includes: mixing titanium tetraisopropanolate with an ammonia aqueous solution to obtain a first mixture, subjecting the first mixture to hydrolysis to obtain a hydrolysis solution, and drying the hydrolysis solution to obtain a titanium dioxide powder; mixing the titanium dioxide powder with sodium polyacrylate and a methyldiethanolamine (MDEA) aqueous solution to obtain a second mixture, and subjecting the second mixture to amination to obtain a solution A; mixing water with ethanol to obtain a solution B; and mixing the solution A and the solution B with a catalyst to obtain a mixed solution, and subjecting the mixed solution to solation to obtain the titanium sol carbon sequestration additive.

### CROSS REFERENCE TO RELATED APPLICATION

The present application is a national stage application of International Patent Application No. PCT/CN2022/132752, filed on Nov. 18, 2022, which claims priority to Chinese Patent Application No. CN202210989726.7 filed to the China National Intellectual Property Administration (CNIPA) on Aug. 18, 2022 and entitled “TITANIUM SOL CARBON SEQUESTRATION ADDITIVE AND PREPARATION METHOD AND USE THEREOF, AND METHOD FOR CARBON SEQUESTRATION OF CEMENT-BASED MATERIAL”, each of which is incorporated herein by reference in its entirety.

### TECHNICAL FIELD

The present disclosure relates to the technical field of carbon sequestration materials, in particular to a titanium sol carbon sequestration additive and a preparation method and use thereof, and a method for carbon sequestration of a cement-based material.

### BACKGROUND

The release and implementation of “carbon peaking and carbon neutrality” strategy has brought higher requirements for green development to the construction industry. Cement, a main raw material for concrete, is one of the most important sources of carbon emissions in the construction industry. As a result, the carbon reduction of concrete materials has become the most concerned issue for researchers at present.

In addition to carbon emission reduction concerning the design of concrete raw materials, the sequestration of CO₂ under the condition of concrete carbonation has become an important way for cement-based materials to achieve the goal of “carbon peaking and carbon neutrality”. However, the continuous carbonation may bring serious problems to the concrete material, such as the carbonation-caused shrinkage and cracking of the concrete, the corrosion of steel bars due to the reduction of alkalinity of the concrete caused by carbonation layer, and the reduction of toughness of the concrete surface after carbonation. It has become a key research and development direction in the field of concrete materials to effectively utilize the advantages of concrete carbonation on CO₂ sequestration, while avoiding the reduction in toughness of concrete materials caused by continuous carbonation.

### SUMMARY

An object of the present disclosure is to provide a titanium sol carbon sequestration additive and a preparation method and use thereof, and a method for carbon sequestration of a cement-based material. In the present disclosure, the titanium sol carbon sequestration additive makes it possible to absorb CO₂ to a greater extent and at a higher rate while improving an overall performance and a quality of the cement-based material.

To achieve the above object, the present disclosure provides the following technical solutions.

Provided is a method for preparing a titanium sol carbon sequestration additive, including the following steps:
mixing titanium tetraisopropanolate with an ammonia aqueous solution to obtain a first mixture, subjecting the first mixture to hydrolysis to obtain a hydrolysis solution, and drying the hydrolysis solution to obtain a titanium dioxide powder;
mixing the titanium dioxide powder with sodium polyacrylate and a methyldiethanolamine (MDEA) aqueous solution to obtain a second mixture, and subjecting the second mixture to amination to obtain a solution A;
mixing water with ethanol to obtain a solution B; and
mixing the solution A and the solution B with a catalyst to obtain a mixed solution, and subjecting the mixed solution to solation to obtain the titanium sol carbon sequestration additive.

In some embodiments, a molar ratio of the titanium tetraisopropanolate to ammonia monohydrate in the ammonia aqueous solution is in a range of 1:(3-15).

In some embodiments, a mass ratio of the titanium dioxide powder to the sodium polyacrylate is in a range of (1100-2200):1; and a mass ratio of the titanium dioxide powder to MDEA in the MDEA aqueous solution is in a range of (0.35-0.40):1.

In some embodiments, the amination is conducted by an ultrasonic treatment, where the ultrasonic treatment is conducted at a frequency of 20 Hz to 25 Hz and a power of 900 W for 15 minutes to 20 minutes.

In some embodiments, in the solution B, a molar ratio of the water to the ethanol is in a range of 1:(5-8).

In some embodiments, a mass ratio of the titanium dioxide powder to the solution B is in a range of 1:(3.5-7); and a mass ratio of the titanium dioxide powder to the catalyst is in a range of (100-150):1.

In some embodiments, the catalyst is selected from the group consisting of polyvinylpyrrolidone (PVP) and carboxymethylcellulose (CMC).

Also provided is a titanium sol carbon sequestration additive prepared by the method described above.

Also provided is use of the titanium sol carbon sequestration additive described above in carbon sequestration of a cement-based material.

Also provided is a method for carbon sequestration of a cement-based material, including the following steps:
coating the titanium sol carbon sequestration additive described above onto a surface of the cement-based material.

The present disclosure provides a method for preparing a titanium sol carbon sequestration additive, including the following steps: mixing titanium tetraisopropanolate with an ammonia aqueous solution to obtain a first mixture, subjecting the first mixture to hydrolysis to obtain a hydrolysis solution, and drying the hydrolysis solution to obtain a titanium dioxide powder; mixing the titanium dioxide powder with sodium polyacrylate and a methyldiethanolamine (MDEA) aqueous solution to obtain a second mixture, and subjecting the second mixture to amination to obtain a solution A; mixing water with ethanol to obtain a solution B; and mixing the solution A and the solution B with a catalyst to obtain a mixed solution, and subjecting the mixed solution to solation to obtain the titanium sol carbon sequestration additive. In the present disclosure, the titanium dioxide powder subjected to the amination has an ability to attract CO₂, making CO₂ more easily adsorbed on the titanium sol carbon sequestration additive, thereby increasing a contact level of the CO₂ with the cement-based material. The titanium sol carbon sequestration additive is coated onto a surface of the cement-based material, which makes it possible to affect hydration of the cement, improve the crystal form and size of calcium hydroxide, and increase a contact area between calcium hydroxide and CO₂, thereby enhancing a carbon sequestration effect. Therefore, the titanium sol carbon sequestration additive of the present disclosure makes it possible to absorb CO₂ to a greater extent and at a higher rate while improving an overall performance and a quality of the cement-based material. The titanium sol carbon sequestration additive of the present disclosure is alkaline, and does not affect the hydration of cement due to pH value after being coated onto the surface of the cement-based material.

The present disclosure further provides a method for carbon sequestration of a cement-based material, including the following steps: coating the titanium sol carbon sequestration additive onto a surface of the cement-based material. In the prior art, nanomaterials, oxides, or special clinker components are generally incorporated into concrete to accelerate early carbonation of the concrete. However, there may be the following problems: (1) the added materials are evenly dispersed in the concrete material, and the improvement of a surface carbonation effect is not obvious enough; (2) a carbonation depth of a surface layer is difficult to be controlled, which easily causes a volume of the surface layer to shrink due to carbonation, resulting in an increase in stiffness and a decrease in toughness of the surface layer. In the present disclosure, the titanium sol carbon sequestration additive in a liquid form is coated onto the surface of the cement-based material, which makes it possible to more accurately control the surface carbonation of the cement-based materials compared with traditional in-situ blending, thereby enhancing a carbonation rate of the surface layer of the cement-based materials and improving a carbon curing effect of the cement-based materials. The present disclosure enhances compactness of the surface layer of the cement-based material during the carbon sequestration, and refines the structure of the surface layer through the carbonation. In this way, while absorbing and solidifying CO₂, the cement-based materials are not negatively affected by continuous carbonation.

### DETAILED DESCRIPTION OF THE EMBODIMENTS

The present disclosure provides a method for preparing a titanium sol carbon sequestration additive, including the following steps:
mixing titanium tetraisopropanolate with an ammonia aqueous solution to obtain a first mixture, subjecting the first mixture to hydrolysis to obtain a hydrolysis solution, and drying the hydrolysis solution to obtain a titanium dioxide powder;
mixing the titanium dioxide powder with sodium polyacrylate and a methyldiethanolamine (MDEA) aqueous solution to obtain a second mixture, and subjecting the second mixture to amination to obtain a solution A;
mixing water with ethanol to obtain a solution B; and
mixing the solution A and the solution B with a catalyst to obtain a mixed solution, and subjecting the mixed solution to solation to obtain the titanium sol carbon sequestration additive.

In the present disclosure, titanium tetraisopropanolate is mixed with an ammonia aqueous solution to obtain a first mixture, the first mixture is subjected to hydrolysis to obtain a hydrolysis solution, and the hydrolysis solution is subjected to drying to obtain a titanium dioxide powder. In some embodiments, a molar ratio of the titanium tetraisopropanolate (Ti{OCH(CH₃)₂}₄) to ammonia monohydrate (NH₄OH) in the ammonia aqueous solution is in a range of 1:(3-15), preferably 1:(9-10). In some embodiments, the ammonia aqueous solution has a mass concentration of 25%.

In some embodiments, the hydrolysis is conducted under stirring, preferably under magnetic stirring. In some embodiments, the hydrolysis is conducted for 30 minutes to 40 minutes, preferably 35 min. In some embodiments, the hydrolysis is conducted at ambient temperature. In some embodiments, the magnetic stirring is conducted at a speed of 400 r/min to 600 r/min, preferably 500 r/min to 550 r/min.

In some embodiments, the drying is conducted at a temperature of 80° C. to 100° C., preferably 90° C. In some embodiments, the titanium dioxide powder has an average particle size of 50 nm. In some embodiments, a molar ratio of the titanium tetraisopropanolate to the titanium dioxide powder is in a range of 1:1. The titanium dioxide powder made in the present disclosure has a high purity.

After the titanium dioxide powder is obtained, the titanium dioxide powder is mixed with sodium polyacrylate and an MDEA aqueous solution to obtain a second mixture, and the second mixture is subjected to amination to obtain a solution A. In some embodiments, a mass ratio of the titanium dioxide powder to the sodium polyacrylate is in a range of (1100-2200):1, preferably (1600-2000):1; and a mass ratio of the titanium dioxide powder to MDEA in the MDEA aqueous solution is in a range of (0.35-0.40):1, preferably (0.38-0.39):1.

In some embodiments, the amination is conducted by an ultrasonic treatment. In some embodiments, the ultrasonic treatment is conducted at a frequency of 20 Hz to 25 Hz and a power of 900 W. In some embodiments, the ultrasonic treatment is conducted for 15 minutes to 20 minutes.

In the present disclosure, water is mixed with ethanol to obtain a solution B. In some embodiments, in the solution B, a molar ratio of the water to the ethanol is in a range of 1:(5-8), preferably 1:(6-7). In some embodiments, the water is deionized water. In some embodiments, the ethanol is absolute ethanol. In some embodiments, the mixing is conducted under magnetic stirring for 5 minutes to 10 minutes.

After the solution A and the solution B are obtained, the solution A is mixed with the solution B and a catalyst to obtain a mixed solution, and the mixed solution is subjected to solation to obtain the titanium sol carbon sequestration additive. In some embodiments, a mass ratio of the titanium dioxide powder to the solution B is in a range of 1:(3.5-7), preferably 1:(5.5-6); and a mass ratio of the titanium dioxide powder to the catalyst is in a range of (100-150):1, preferably 100:1. In some embodiments, the catalyst is selected from the group consisting of PVP and CMC.

In some embodiments, mixing the solution A and the solution B with the catalyst includes: adding the catalyst after mixing the solution A and the solution B.

In some embodiments, the solation is conducted at a temperature of 30° C. to 40° C., preferably 35° C. In some embodiments, the solation is conducted for 0.5 hours to 1 hour. In some embodiments, the solation is conducted under stirring at a speed of 1,300 r/min to 1,500 r/min, preferably 1,400 r/min.

In some embodiments, after the solation, the obtained sol is cooled to ambient temperature and then stored at a temperature of 0° C. to 10° C.

The present disclosure further provides a titanium sol carbon sequestration additive prepared by the method described above. In some embodiments, the titanium sol carbon sequestration additive is in a liquid form, with a viscosity of (6-8) mm²/s. In some embodiments, the titanium sol carbon sequestration additive has a pH value of 12.

The present disclosure further provides use of the titanium sol carbon sequestration additive described above in carbon sequestration of a cement-based material. In some embodiments, the titanium sol carbon sequestration additive is used in the carbon sequestration of concrete.

The present disclosure further provides a method for carbon sequestration of a cement-based material, including the following steps:
coating the titanium sol carbon sequestration additive described above onto a surface of the cement-based material. In some embodiments, a surface of the cement-based material is cleaned before the coating. There is no special limitation on a method of the cleaning, as long as impurities on the surface of the cement-based material could be removed. In some embodiments, the cement-based material is concrete. In a specific example, the cement-based material is cement mortar.

In some embodiments, the coating is performed by brush coating. In some embodiments, the titanium sol carbon sequestration additive is coated at an amount of (400-500) g/m², preferably 450 g/m².

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the protection scope of the present disclosure.

### Example 1

(1) Titanium tetraisopropanolate and an ammonia aqueous solution with a mass concentration of 25%, at a molar ratio of Ti{OCH(CH₃)₂}₄:NH₄OH=1:15, were mixed evenly by magnetic stirring at 600 r/min for 40 minutes; and an obtained hydrolysis reaction solution was dried at 90° C. to form a powder, namely a titanium dioxide powder; and
amination of the titanium dioxide powder: the titanium dioxide powder was mixed with sodium polyacrylate and an MDEA aqueous solution, where a mass ratio of the titanium dioxide powder to the sodium polyacrylate was 1100:1, and a mass ratio of the titanium dioxide powder to MDEA in the MDEA aqueous solution was 0.35:1; a resulting mixture was ultrasonically dispersed at a power of 900 W and a frequency of 20 Hz for 20 minutes to obtain a solution A.

(2) Deionized water and absolute ethanol, at a molar ratio of H₂O:EtOH=1:5, were uniformly mixed by magnetic stirring for 5 minutes to obtain a solution B.

(3) 500 mL of the solution A and 1,000 mL of the solution B were poured into a three-necked flask, the three-necked flask was placed in an instant-heating constant-temperature magnetic heating stirrer, and 0.01 g of a catalyst PVP was added into the three-necked flask; constant-temperature stirring was conducted at 40° C. and 1,500 r/min for 1 hour; and then the stirrer was stopped, and an obtained sol was cooled to ambient temperature to obtain a titanium sol carbon sequestration additive. The titanium sol carbon sequestration additive was stored at 0° C. to 10° C.

### Use Example 1

The cement mortar was put into a mold for 3 days and demolded, and then a surface of the mortar exposed to the air was cleaned to remove an oily release agent on the surface of the mortar.

The titanium sol carbon sequestration additive prepared in Example 1 was evenly coated onto the surface of the cleaned mortar by brush coating in an amount of 400 g/m² to obtain a test piece.

### Example 2

(1) Titanium tetraisopropanolate and an ammonia aqueous solution with a mass concentration of 25%, at a molar ratio of Ti{OCH(CH₃)₂}₄:NH₄OH=1:17.5, were mixed evenly by magnetic stirring at 550 r/min for 35 minutes; and an obtained hydrolysis reaction solution was dried at 90° C. to form a powder, namely a titanium dioxide powder; and
amination of the titanium dioxide powder: the titanium dioxide powder was mixed with sodium polyacrylate and an MDEA aqueous solution, where a mass ratio of the titanium dioxide powder to the sodium polyacrylate was 1600:1, and a mass ratio of the titanium dioxide powder to MDEA in the MDEA aqueous solution was 0.38:1; a resulting mixture was ultrasonically dispersed at a power of 900 W and a frequency of 20 Hz for 20 minutes to obtain a solution A.

(2) Deionized water and absolute ethanol, at a molar ratio of H₂O:EtOH=1:6, were uniformly mixed by magnetic stirring for 8 minutes to obtain a solution B.

(3) 500 mL of the solution A and 500 mL of the solution B were poured into a three-necked flask, the three-necked flask was placed in an instant-heating constant-temperature magnetic heating stirrer, and 0.01 g of a catalyst PVP was added into the three-necked flask; constant-temperature stirring was conducted at 35° C. and 1,400 r/min for 1 hour; and then the stirrer was stopped, and an obtained sol was cooled to ambient temperature to obtain a titanium sol carbon sequestration additive. The titanium sol carbon sequestration additive was stored at 0° C. to 10° C.

### Use Example 2

The cement mortar was put into a mold for 3 days and demolded, and then a surface of the mortar exposed to the air was cleaned to remove an oily release agent on the surface of the mortar.

The titanium sol carbon sequestration additive prepared in Example 2 was evenly coated onto the surface of the cleaned mortar by brush coating in an amount of 450 g/m² to obtain a test piece.

### Example 3

(1) Titanium tetraisopropanolate and an ammonia aqueous solution with a mass concentration of 25%, at a molar ratio of Ti{OCH(CH₃)₂}₄:NH₄OH=1:20, were mixed evenly by magnetic stirring at 500 r/min for 30 minutes; and an obtained hydrolysis reaction solution was dried at 90° C. to form a powder, namely a titanium dioxide powder; and
amination of the titanium dioxide powder: the titanium dioxide powder was mixed with sodium polyacrylate and an MDEA aqueous solution, where a mass ratio of the titanium dioxide powder to the sodium polyacrylate was 2200:1, and a mass ratio of the titanium dioxide powder to MDEA in the MDEA aqueous solution was 0.40:1; a resulting mixture was ultrasonically dispersed at a power of 900 W and a frequency of 20 Hz for 20 minutes to obtain a solution A.

(2) Deionized water and absolute ethanol, at a molar ratio of H₂O:EtOH=1:7, were uniformly mixed by magnetic stirring for 10 minutes to obtain a solution B.

(3) 500 mL of the solution A and 500 mL of the solution B were poured into a three-necked flask, the three-necked flask was placed in an instant-heating constant-temperature magnetic heating stirrer, and 0.01 g of a catalyst CMC was added into the three-necked flask; constant-temperature stirring was conducted at 30° C. and 1,300 r/min for 1 hour; and then the stirrer was stopped, and an obtained sol was cooled to ambient temperature to obtain a titanium sol carbon sequestration additive. The titanium sol carbon sequestration additive was stored at 0° C. to 10° C.

### Use Example 3

The cement mortar was put into a mold for 3 days and demolded, and then a surface of the mortar exposed to the air was cleaned to remove an oily release agent on the surface of the mortar.

The titanium sol carbon sequestration additive prepared in Example 3 was evenly coated onto the surface of the cleaned mortar by brush coating in an amount of 500 g/m² to obtain a test piece.

### Blank Group

The cement mortar was put into a mold for 3 days and demolded, and then a surface of the mortar exposed to the air was cleaned to remove an oily release agent on the surface of the mortar, to obtain a reference group test piece.

### Comparative Example 1

3% nano-titanium dioxide (mass percentage by cement amount) was added during the preparation of cement mortar. The cement mortar was put into a mold for 3 days and demolded, and then a surface of the mortar exposed to the air was cleaned to remove an oily release agent on the surface of the mortar, to obtain a test piece of Comparative Example 1.

### Test Example

3-day CO₂ absorption and carbonation depth, and 28-day CO₂ absorption and carbonation depth of the cement-based materials in Use Examples 1 to 3, the blank group, and Comparative Example 1 were tested; 3-day volumetric deformation of these cement-based materials was tested; and 28-day strength change (compressive strength/flexural strength) of these cement-based materials was tested.

### 1. Preparation of Cement Mortar in Use Examples 1 to 3, Blank Group, and Comparative Example 1

TABLE 1
Basic information of raw materials of cement mortar for test

| Material | Cement | Sand | Water |
|---|---|---|---|
| Basic information | Benchmark cement | Standard sand | Tap water |

TABLE 2
Mixing ratios of raw materials of cement mortar for test (kg/m³)

| | | | | Water-cement | Water |
|---|---|---|---|---|---|
| Group | Cement | Sand | Water | ratio | reducer |
| Use Example 1 | 450 | 1350 | 225 | 0.5 | 5.0 |
| Use Example 2 | | | | | 4.5 |
| Use Example 3 | | | | | 5.0 |
| Blank group | | | | | 4.5 |
| Comparative | | | | | 6.5 |
| Example 1 | | | | | |

The cement mortars of Use Examples 1 to 3, the blank group, and Comparative Example 1 were prepared according to Table 2. An initial expansion was controlled at 180 mm to 200 mm, the water consumption was strictly controlled, and the working performance was controlled by the water reducer.

TABLE 3
Dimensions (mm) and quantity (blocks)
of molded test pieces in each group

| Test piece dimension | Corresponding test | Quantity |
|---|---|---|
| 100 mm × 100 mm × | Carbonation depth, carbon | 12 |
| 100 mm | sequestration content | |
| 40 mm × 40 mm × 160 mm | Volume change, strength change | 9 |

The test pieces of Use Examples 1 to 3, the blank group, and Comparative Example 1 were placed in a closed carbonation box (with a constant CO₂ concentration of 3%±0.5%, and a constant humidity of 60%±5%), and taken out on specified time 3 days and 28 days separately. The carbonation depth/CO₂ absorption, volume change, and flexural strength/compressive strength of the test pieces were tested. In each group, 3 test pieces were taken from each test at each test time point, and the test results were an average value of the 3 test pieces.

### 2. Results of CO₂ Absorption and Carbonation Depth

Before the test pieces for CO₂ absorption and carbonation depth test were put into the carbonation box, except for the coated surface (the test pieces of the blank group and Comparative Example 1 retained a flat non-formed surface), the other 5 surfaces were subjected to wax (paraffin) sealing. This ensured one-dimensional infiltration of CO₂, enhancing the accuracy of test results.

TABLE 4
Carbonation depth of test pieces in each group (mm)

| Carbonation | Blank | Comparative | Use | Use | Use |
|---|---|---|---|---|---|
| time | group | Example 1 | Example 1 | Example 2 | Example 3 |
| 3 days | 3.1 | 2.8 | 2.2 | 2.4 | 2.5 |
| 28 days | 8.3 | 6.8 | 2.9 | 2.6 | 2.8 |

TABLE 5
Carbon sequestration (by CaCO₃) content
(g) of test pieces in each group

| Carbonation | Blank | Comparative | Use | Use | Use |
|---|---|---|---|---|---|
| time | group | Example 1 | Example 1 | Example 2 | Example 3 |
| 3 days | 4.8 | 6.2 | 6.6 | 7.4 | 6.8 |
| 28 days | 19.9 | 17.7 | 14.7 | 13.6 | 14.2 |

In the Comparative Example 1 mixed with nano-titanium dioxide, the introduction of nanomaterials enhanced the compactness of the cement mortar surface, and the early carbonation depth was reduced. However, as the carbonation time increased, the carbonation depth still increased to a certain extent. For Use Examples 1 to 3 with external coating, the carbonation depth was further reduced in the early stage, and the continuous diffusion of CO₂ was effectively suppressed. This resulted in almost no change in the carbonation depth at 28 d, and the carbonation depth increased from 0.2 mm to 0.7 mm from 3 days to 28 days.

From Table 5, it can be seen that the increase of carbonation depth directly leads to the increase of carbon sequestration content. However, for Comparative Example 1 with nano-titanium dioxide added and Use Examples 1 to 3 externally coated with the titanium sol carbon sequestration additive, even though the early carbonation depth is smaller than that of the blank group, more carbon dioxide is absorbed. Moreover, a later carbon sequestration absorption rate (considering the carbonation depth) of Use Examples 1 to 3 is higher than that of the Comparative Example 1. This is mainly due to the influence of nano-titanium dioxide on the hydration of cement, promoting the production of more carbonated calcium hydroxide.

### 3. Volumetric Deformation Results

The test pieces in each group were put into the carbonation box after being treated, and the lengths of the test pieces were tested before putting, 1 day after putting, 2 days after putting, and 3 days after putting, respectively. The test results are shown in the table below:

TABLE 6
Dimensional changes (mm) of test pieces in each group from
1 day to 3 days after being placed in the carbonation box

| Carbonation | Blank | Comparative | Use | Use | Use |
|---|---|---|---|---|---|
| time | group | Example 1 | Example 1 | Example 2 | Example 3 |
| Before putting | 160.1 | 160.0 | 160.1 | 160.2 | 160.1 |
| 1 day | 159.4 | 159.5 | 159.8 | 160.1 | 159.9 |
| 2 days | 159.1 | 159.0 | 159.8 | 160.1 | 159.8 |
| 3 days | 158.5 | 158.3 | 159.7 | 160.0 | 159.8 |

As shown in Table 6, for the blank group and Comparative Example 1, the continuous carbonation leads to volume shrinkage of the test piece, with a shrinkage amplitude as high as 1.6 mm. If the test piece is enlarged in the same proportion, it might cause a highly serious impact on the actual project. However, for Use Examples 1 to 3 externally coating with the titanium sol carbon sequestration additive, the volume of the test piece is hardly changed during the carbon sequestration.

### 4. Strength Change

Referring to GB/T 17671-1999 “Method of testing cements-Determination of strength (ISO method)”, the flexural and compressive strengths of the test pieces in each group for 3 days and 28 days were tested. The toughness of the test piece was characterized by a ratio of the flexural strength to the compressive strength, that is, a larger ratio of the flexural strength to the compressive strength, a better toughness of the test piece, and a less prone to brittle fracture of the test piece. The specific test results are shown in Table 7:

TABLE 7
Strength changes of the test pieces in each group after 3
days and 28 days after being placed in the carbonation box

| | | | | 28-day |
|---|---|---|---|---|
| | | 3 | 28 | toughness |
| Carbonation time | Strength (MPa) | days | days | (%) |
| Blank group | Flexural strength | 2.6 | 7.1 | 16.0 |
| Standard curing | Compressive strength | 22.3 | 44.3 | |
| Blank group | Flexural strength | 3.2 | 7.3 | 15.3 |
| | Compressive strength | 24.1 | 47.5 | |
| Comparative | Flexural strength | 5.3 | 8.9 | 16.9 |
| Example 1 | Compressive strength | 26.5 | 52.5 | |
| Use Example 1 | Flexural strength | 5.4 | 9.1 | 18.3 |
| | Compressive strength | 25.4 | 49.8 | |
| Use Example 2 | Flexural strength | 5.8 | 10.3 | 19.3 |
| | Compressive strength | 26.1 | 53.5 | |
| Use Example 3 | Flexural strength | 5.5 | 9.2 | 18.4 |
| | Compressive strength | 25.8 | 50.1 | |

As shown in Table 7, for Comparative Example 1 with nano-titanium dioxide and Use Examples 1 to 3 externally coating with the titanium sol carbon sequestration additive, the compressive and flexural strengths of cement mortar at 3 days and 28 days are higher than those of the blank group. Moreover, the toughness of Use Examples 1 to 3 externally coating with the titanium sol carbon sequestration additive is also improved, thereby addressing the problem of the reduction of toughness of cement-based materials caused by carbonation. In addition, the toughness of the test pieces in the blank group in a carbonation environment is lower than that in the standard curing.

The above description of embodiments is merely provided to help understand the method of the present disclosure and a core idea thereof. It should be noted that, several improvements and modifications may be made by those skilled in the art without departing from the principle of the present disclosure, and these improvements and modifications should also fall within the protection scope of the present disclosure. Various amendments to these embodiments are apparent to those skilled in the art, and the general principles defined herein may be implemented in other embodiments without departing from the spirit or scope of the present disclosure. Thus, the present disclosure is not limited to the embodiments shown herein but falls within the widest scope consistent with the principles and novel features disclosed herein.

What is claimed is:

1. A method for preparing a titanium sol carbon sequestration additive, comprising the following steps:
mixing titanium tetraisopropanolate with an ammonia aqueous solution to obtain a first mixture, subjecting the first mixture to hydrolysis to obtain a hydrolysis solution, and drying the hydrolysis solution to obtain a titanium dioxide powder;
mixing the titanium dioxide powder with sodium polyacrylate and a methyldiethanolamine (MDEA) aqueous solution to obtain a second mixture, and subjecting the second mixture to amination to obtain a solution A;
mixing water with ethanol to obtain a solution B; and
mixing the solution A and the solution B with a catalyst to obtain a mixed solution, and subjecting the mixed solution to solation to obtain the titanium sol carbon sequestration additive.

2. The method of claim 1, wherein a molar ratio of the titanium tetraisopropanolate to ammonia monohydrate in the ammonia aqueous solution is in a range of 1:(3-15).

3. The method of claim 1, wherein the hydrolysis is conducted at ambient temperature for 30 minutes to 40 minutes.

4. The method of claim 1, wherein a mass ratio of the titanium dioxide powder to the sodium polyacrylate is in a range of (1100-2200):1.

5. The method of claim 1, wherein a mass ratio of the titanium dioxide powder to MDEA in the MDEA aqueous solution is in a range of (0.35-0.40):1.

6. The method of claim 1, wherein the amination is conducted by an ultrasonic treatment; and the ultrasonic treatment is conducted at a frequency of 20 Hz to 25 Hz and a power of 900 W for 15 minutes to 20 minutes.

7. The method of claim 1, wherein in the solution B, a molar ratio of the water to the ethanol is in a range of 1:(5-8).

8. The method of claim 1, wherein a mass ratio of the titanium dioxide powder to the solution B is in a range of 1:(3.5-7).

9. The method of claim 1, wherein a mass ratio of the titanium dioxide powder to the catalyst is in a range of (100-150):1.

10. The method of claim 1, wherein the catalyst is selected from the group consisting of polyvinylpyrrolidone (PVP) and carboxymethylcellulose (CMC).

11. The method of claim 1, wherein the solation is conducted at a temperature of 30° C. to 40° C.; and the solation is conducted for 0.5 hours to 1 hour.

12. The method of claim 1, wherein the solation is conducted under stirring at a speed of 1,300 r/min to 1,500 r/min.

13. A titanium sol carbon sequestration additive prepared by the method of claim 1.

14. The titanium sol carbon sequestration additive of claim 13, wherein the titanium sol carbon sequestration additive has a pH value of 12.

15. (canceled)

16. A method for carbon sequestration of a cement-based material, comprising the following steps:
coating the titanium sol carbon sequestration additive of claim 13 onto a surface of the cement-based material.

17. The method of claim 16, wherein the titanium sol carbon sequestration additive is coated at an amount of 400 g/m² to 500 g/m².

18. The method of claim 2, wherein the hydrolysis is conducted at ambient temperature for 30 minutes to 40 minutes.

19. The method of claim 4, wherein the amination is conducted by an ultrasonic treatment; and the ultrasonic treatment is conducted at a frequency of 20 Hz to 25 Hz and a power of 900 W for 15 minutes to 20 minutes.

20. The method of claim 9, wherein the catalyst is selected from the group consisting of polyvinylpyrrolidone (PVP) and carboxymethylcellulose (CMC).
